(19) United States
(12) Patent Application Publication
(10) Pub. No.: US 2016/0046331 A1
(43) Pub. Date: Feb. 18, 2016

(54) Hybrid Component for a Motor Vehicle Comprising an Internal, Unsprayed Metal Grid Having a Rhomboid Pattern

(71) Applicant: Bayerische Motoren Werke Aktiengesellschaft, Muenchen (DE)

(72) Inventors: Thomas HOGGER, Otterfing (DE); Florian MOSSMANN, Offenburg (DE)

(21) Appl. No.: 14/926,981

(22) Filed: Oct. 29, 2015

Related U.S. Application Data
(63) Continuation of application No. PCT/EP2014/057665, filed on Apr. 15, 2014.

(30) Foreign Application Priority Data
Apr. 30, 2013 (DE) 10 2013 207 982.6

(51) Int. Cl. B62D 29/00

(52) U.S. Cl. CPC B62D 29/004

(57) ABSTRACT

A hybrid component for a vehicle includes at least one metal element and a plastic element. The plastic element at least sectionally encloses the at least one metal element, and at least sectionally forms a form-fit with the at least one metal element. The hybrid component is configured to form an at least friction-locked and/or integrally-joined connection with a body-side element of a vehicle. The form-fit between the at least one metal element and the plastic element is produced at least via one or more holes, which are formed and/or arranged such that a stiffness of the hybrid component is reduced in a main direction of thermal expansion of the hybrid component in relation to a direction that is different from a main direction of thermal expansion.

### CROSS REFERENCE TO RELATED APPLICATIONS

This application is a continuation of PCT International Application No. PCT/EP2014/057665, filed Apr. 15, 2014, which claims priority under 35 U.S.C. §119 from German Patent Application No. 10 2013 207 982.6, filed Apr. 30, 2013, the entire disclosures of which are herein expressly incorporated by reference.

### BACKGROUND AND SUMMARY OF THE INVENTION

Embodiments, the invention relate to a hybrid component for a vehicle, in particular for a motor vehicle, which comprises at least one metal element and one plastic element, which encloses the metal element and forms at least one form-fit with the metal element, wherein the hybrid component is configured to establish an at least friction-locked and/or integrally-joined connection with a body-side element of a vehicle.

Furthermore, in some embodiments the invention relates to a vehicle having such a hybrid component.

Hybrid components have increasingly found use in conjunction with motor vehicles in the meantime.

The respective material properties are typically of great significance in particular in the dimensioning of components for motor vehicles and also the corresponding material selection with regard to the corresponding component requirements or stresses in the vehicle. Against this background, metal materials are most frequently used in motor vehicles, for example, in mechanically (statically or dynamically) stressed components, and plastic materials, for example, under aspects with respect to the weight reduction of motor vehicles or from aesthetic considerations.

Hybrid components comprise at least two different materials. The usage of hybrid components offers the advantage, inter alia, of bringing different components into combination with one another in a molded part, to thus advantageously combine the desired material properties of both materials. A composite material having physical properties which would not be achievable using homogeneous materials thus results. The manufacturing of hybrid components is also typically based on the combination of two conventional production methods, namely metal deep drawing and plastic injection molding.

One example of a conventional design and production principle of hybrid components is embodied as follows: a deep-drawn and typically perforated steel plate part is laid in an injection mold, similarly to the insert technique, and extrusion coated using a suitable plastic. In this case, the plastic melt penetrates through the stamped openings or holes of the steel plate and forms a rivet head between the mold dimensioning wall of the mold and the inserted metal part. A highly-loadable friction-locked and formfitting connection between the two components results in this manner.

A weight reduction of motor vehicles is achieved via the use of hybrid components in conjunction with motor vehicles, for example, which can therefore be operated with lower emission and reduced fuel consumption.

However, the use of hybrid components is subject to problems insofar as at least the metal element of the hybrid component can result in a tension buildup in the connection or coupling of the hybrid component to the vehicle body part upon attachment to a body-side component or element of the motor vehicle as a result of the coefficient of thermal expansion of the metal element. This is true in particular if a friction-locked and/or integrally-joined connection, such as, for example, an adhesive bond exists between the hybrid component and the vehicle body component. Such a tension buildup occurs, for example, upon the use of a metal element made of aluminum, which can result in high tensions in the integrally-joined connection, namely the adhesive bond or adhesive layer between the plastic element and the body-side component. A dissipation of the tensions does take place in this integrally-joined connection. However, the connection between the components is thus lastingly impaired.

Embodiments of the present invention therefore have as one object, that of refining the hybrid components of the type in question such that tensions in the integrally-joined and/or friction-locked connection between the hybrid component and the body-side component, which are induced in particular by thermal expansion, can be kept as low as possible.

This and other objects are achieved by the features of the independent claims in this application. Advantageous embodiments and refinements of the embodiments of the invention result from the dependent claims in this application.

The hybrid component according to an embodiment of the invention for a vehicle, in particular for a motor vehicle, comprises at least one metal element and a plastic element, which at least sectionally encloses the metal element and at least sectionally forms a form-fit with the metal element, wherein the hybrid component is configured to form an at least frictionally-locked and/or integrally-joined connection to a body-side element of a vehicle, wherein the form-fit between the metal element and the plastic element is produced at least via one or more holes, which are formed and/or arranged such that a stiffness of the hybrid component in a main direction of thermal expansion of the hybrid component is reduced in relation to a direction different from the main direction of thermal expansion. In particular, the holes are formed and/or arranged in the metal element so that a compression of the hybrid component is promoted in the direction of thermal expansion and an expansion of the hybrid component is promoted in a direction perpendicular to the main direction of thermal expansion. Accordingly, stresses occurring in the integrally-joined and/or friction-locked connection, which originate above all from the thermal expansion of the metal element, can at least be reduced.

The hybrid component according to an embodiment of the invention can be refined such that the holes are formed as rhomboid.

Furthermore, the hybrid component according to an embodiment of the invention can be embodied so that the holes form a hole pattern, in which holes, which are adjacent in the main direction of thermal expansion, are arranged so that respective rhombus corners of the adjacent holes are opposite to one another or adjoin one another.

In addition, the hybrid component according to an embodiment of the invention can be implemented such that the holes form a hole pattern having multiple rows of holes lying in parallel to one another, in which holes of a first row, which are adjacent in the main direction of thermal expansion, are arranged so that respective rhombus corners of the adjacent holes of the first row are opposite to one another or adjoin one another, and holes of a second row, which is spaced apart from the first row, which are adjacent to one another in the main direction of thermal expansion, are arranged so that respective holes of the second row are each arranged between two adjacent holes of the first row.

Alternatively or additionally, the hybrid component according to the invention can be implemented so that the holes form a hole pattern having multiple rows of holes lying in parallel to one another, in which holes of a first row, which are adjacent to one another in the main direction of thermal expansion, are arranged so that respective rhombus corners of the adjacent holes of the first row are opposite one another, and holes of a second row, which is spaced apart from the first row, which are adjacent to one another in the main direction of thermal expansion, are arranged so that respective holes of the second row are each arranged between two adjacent holes of the first row, so that respective rhombus sides of two adjacent holes of the first row are parallel to respective rhombus sides of an adjacent hole of the second row.

Furthermore, the hybrid component according to an embodiment of the invention can be embodied so that an attachment section of the metal element protrudes from the plastic element.

The vehicle according to an embodiment of the invention, in particular a motor vehicle, comprises the hybrid component according to an embodiment of the invention, wherein the hybrid component is connected in a friction-locked and/or integrally-joined manner to a vehicle body component of the vehicle. Thus, the properties mentioned in conjunction with the hybrid component according to an embodiment of the invention result in an identical or similar manner, because of which reference is made to the disclosure pertaining to the hybrid component to avoid repetitions.

An embodiment of the invention will be explained as an example hereafter on the basis of the figures.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an illustration of a hybrid component according to an embodiment of the invention;

FIG. 2 shows an illustration of the hybrid component according to the invention from FIG. 1 in a view in which both a plastic element and a metal element of the hybrid component are made visible; and

FIG. 3 shows an illustration of the metal element of the hybrid component according to the embodiment from FIG. 2.

### DETAILED DESCRIPTION OF THE DRAWINGS

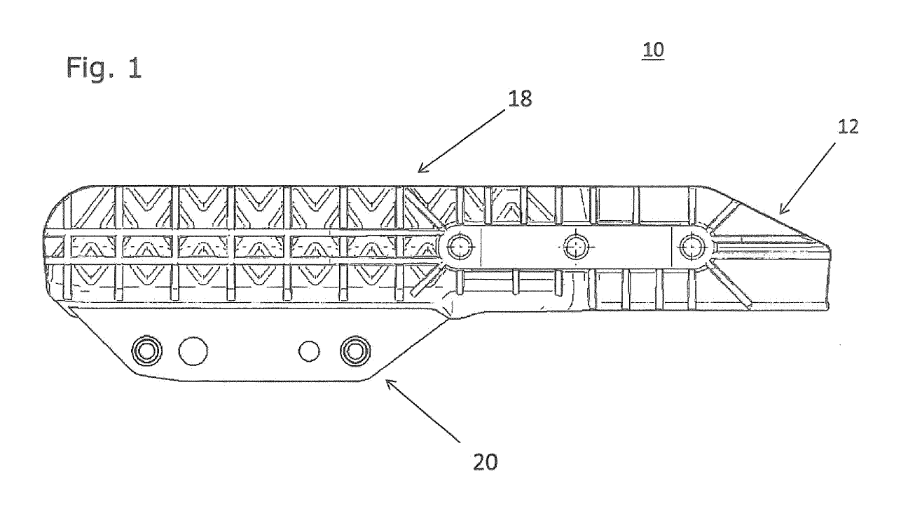

FIG. 1 shows an illustration of a hybrid component 10 according to an embodiment of the invention, which fundamentally comprises at least two materials. In this case, the hybrid component 10 comprises a plastic element 12 made of a thermoplastic and a metal element 14 made of aluminum, for example. In this case, the hybrid component 10 has been produced in the above-described conventional manner.

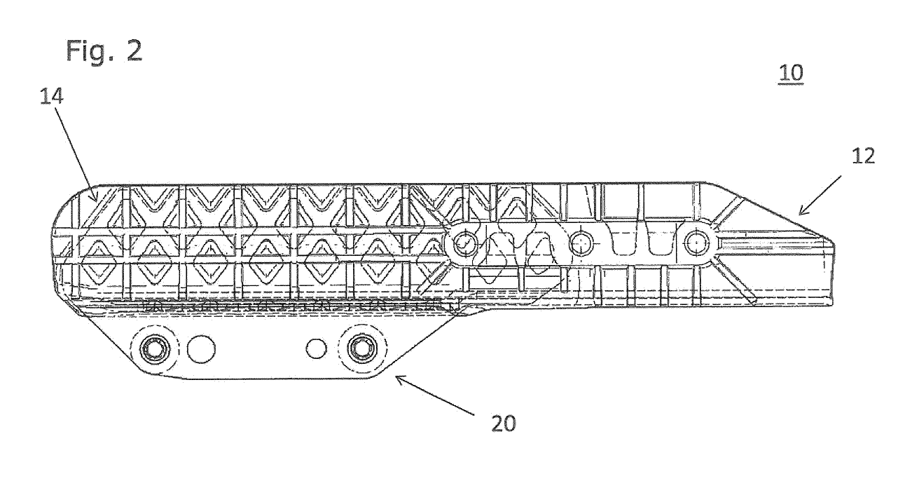

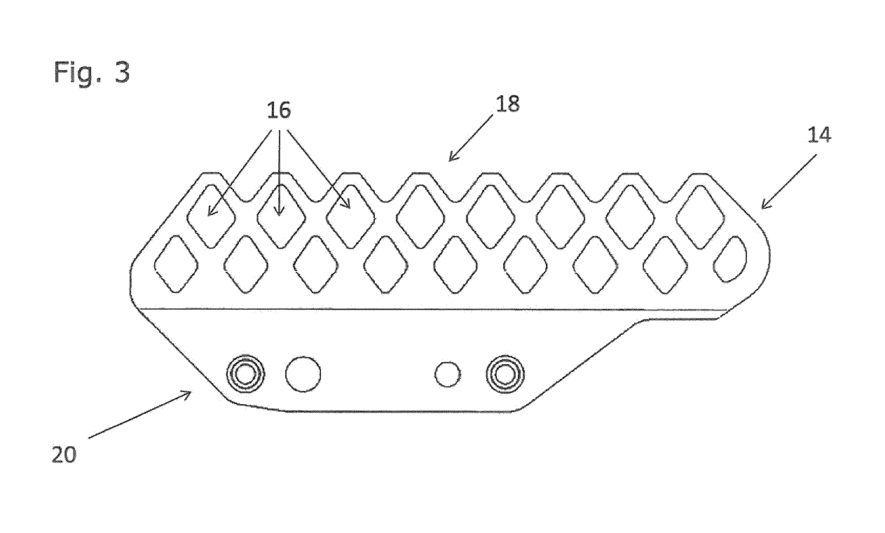

FIG. 2 shows an illustration of the hybrid component 10 from FIG. 1 in a view in which both the plastic element 12 and the metal element 14 of the hybrid component 10 are made visible, wherein FIG. 3 shows an illustration of only the metal element 14 of the hybrid component 10.

The hybrid component 10 is provided in this case for a motor vehicle and comprises the metal element 14 and the plastic element 12, which at least sectionally encloses the metal element 14 and at least sectionally forms a form-fit with the metal element 14. In other words, the metal element 14 is extrusion-coated by the plastic element 112.

Furthermore, the hybrid component 10 is configured to form an at least friction-locked and/or integrally-joined connection with a body-side element of the motor vehicle, wherein the hybrid component in this exemplary embodiment is thus in particular embodied as a vehicle jack receptacle for lifting the motor vehicle via a vehicle jack. For this purpose, the hybrid component is glued onto a vehicle body component in this exemplary embodiment, whereby an integrally-joined connection is produced between the hybrid component 10 and the vehicle body component.

In the hybrid component 10, the form-fit between the metal element 14 and the plastic element 12 is produced by multiple holes 16, which are formed and arranged such that a stiffness of the hybrid component 10 is reduced in a main direction of thermal expansion of the hybrid component 10 in relation to a direction that is different from the main direction of thermal expansion.

In this case, the main direction of thermal expansion corresponds to the longitudinal extension direction of the hybrid component 10, which forms the left to right direction in FIGS. 1 to 3. In contrast, the transverse extension direction of the hybrid component 10, which is perpendicular to the longitudinal extension direction, is the direction pointing from bottom to top in FIGS. 1 to 3. As is apparent from FIGS. 1 to 3, the hybrid component 10 has a longitudinal extension which is multiple times greater than a width extension in comparison to the width extension. Accordingly, the longitudinal extension direction represents the main direction of thermal expansion of the hybrid component 10 in this case.

In this exemplary embodiment, the holes 16 are formed as rhomboid, as is recognizable in particular in FIG. 3. Furthermore, the holes 16 form a hole pattern 18, in which holes 16, which are adjacent in the main direction of thermal expansion, are arranged so that respective rhombus corners of the adjacent holes 16 are opposite to one another or adjoin one another. In particular, the holes 16 form the hole pattern 18 having multiple rows of holes lying in parallel to one another, in which holes 16 of a first row, which are adjacent to one another in the main direction of thermal expansion, are arranged so that respective rhombus corners of the adjacent holes 16 of the first row are opposite to one another or adjoin one another, and holes 16 of a second row, which is spaced apart from the first row, which are adjacent to one another in the main direction of thermal expansion, are arranged so that respective holes 16 of the second row are each arranged between two adjacent holes 16 of the first row. In this case, the respective holes 16 of the second row are each arranged between two adjacent holes of the first row such that respective rhombus sides of two adjacent holes 16 of the first row are parallel to respective rhombus sides of an adjacent hole 16 of the second row.

As is apparent from FIGS. 1 and 2 in particular, an attachment section 20 of the metal element 14 for attachment of a force-absorbing element, on which the vehicle jack finally engages, protrudes from the plastic element 12. As is apparent from FIGS. 1 and 2 in particular, the metal element is extrusion coated by the plastic element 12 such that the attachment section 20 of the metal element 14 protrudes from the plastic element 12 without plastic extrusion coating.

### LIST OF REFERENCE SIGNS

10 hybrid component
12 plastic element or plastic component
14 metal element or metal component
16 hole or holes
18 rhombus hole pattern
20 attachment section

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A hybrid component for a vehicle, the hybrid comprising:
at least one metal element; and
a plastic element, which at least sectionally encloses the at least one metal element and at least sectionally forms a form-fit with the at least one metal element, wherein
the hybrid component is configured to form an at least friction-locked and/or integrally-joined connection with a body-side element of a vehicle,
the form-fit between the at least one metal element and the plastic element is produced at least via one or more holes, which are formed and/or arranged such that a stiffness of the hybrid component is reduced in a main direction of thermal expansion of the hybrid component in relation to a direction that is different from a main direction of thermal expansion.

2. The hybrid component according to claim 1, wherein the holes are formed as rhomboid.

3. The hybrid component according to claim 2, wherein the holes form a hole pattern, in which holes that are adjacent in the main direction of thermal expansion are arranged so that respective rhombus corners of the adjacent holes are opposite to one another or adjoin one another.

4. The hybrid component according to claim 1, wherein the holes form a hole pattern having multiple rows of holes lying in parallel to one another, in which holes of a first row, which are adjacent in the main direction of thermal expansion, are arranged so that respective rhombus corners of the adjacent holes of the first row are opposite to one another or adjoin one another, and holes of a second row, which is spaced apart from the first row, which are adjacent to one another in the main direction of thermal expansion, are arranged so that respective holes of the second row are each arranged between two adjacent holes of the first row.

5. The hybrid component according to claim 1, wherein the holes form a hole pattern having multiple rows of holes lying in parallel to one another, in which holes of a first row, which are adjacent to one another in the main direction of thermal expansion, are arranged so that respective rhombus corners of the adjacent holes of the first row are opposite to one another, and holes of a second row, which is spaced apart from the first row, which are adjacent to one another in the main direction of thermal expansion, are arranged so that respective holes of the second row are each arranged between two adjacent holes of the first row, so that respective rhombus sides of two adjacent holes of the first row are parallel to respective rhombus sides of an adjacent hole of the second row.

6. The hybrid component according to claim 5, wherein an attachment section of the at least one metal element protrudes from the plastic element.

7. A vehicle, in particular a motor vehicle, having the hybrid component according to claim 6, wherein the hybrid component is connected in a friction-locked and/or integrally-joined manner to a vehicle body part of the vehicle.
